(19) United States
(12) Patent Application Publication
(10) Pub. No.: US 2009/0080892 A1
(43) Pub. Date: Mar. 26, 2009

(54) NETWORK APPARATUS AND METHOD FOR GUARANTEEING ROLE OF OPTICAL SUPERVISORY CHANNEL

(75) Inventors: Sun-hyok Chang, Daejeon (KR); Hwan-seok Chung, Daejeon (KR); Sang-soo Lee, Daejeon (KR); Young-hwa Kim, Daejeon (KR); Kwang-joon Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/121,435

(22) Filed: May 15, 2008

(30) Foreign Application Priority Data
Sep. 20, 2007 (KR) 10-2007-0096144

(51) Int. Cl. H04J 14/02

(52) U.S. Cl. 398/79

(57) ABSTRACT

A network node and method for guaranteeing the role of an optical supervisory channel (OSC) in an optical transport network (OTN) are provided. In the network node, at least two OSC units are multiplexed, one of the OSC units is set as a main unit, the other OSC unit is set as an auxiliary unit; and the auxiliary unit is activated when the main unit cannot be operated. Thereby, the network node can guarantee the stable role of the OSC.

### CROSS REFERENCE TO RELATED APPLICATIONS

This application claims priority from Korean Patent Application No. 10-2007-0096144, filed on Sep. 20, 2007, the disclosure of which is incorporated herein in its entirety by reference.

### BACKGROUND OF THE INVENTION

1. Field of the Invention

The present invention relates to an optical network based on wavelength division multiplexing optical transmission technology, and more particularly, to a network node for guaranteeing the role of an optical supervisory channel (OSC) in an optical transport network (OTN).

This work was supported by the IT R&D program of MIC/IITA [2006-S-059-02, ASON-based metro photonic cross-connect technology].

2. Description of the Related Art

Wavelength division multiplexing (WDM) optical transmission technology is rising as a solution to the sharp increase in demand for transmission capacity. The WDM optical transmission technology makes it possible to simultaneously transfer a plurality of wavelengths through a single optical fiber. For example, assuming that one wavelength channel transfers 50 wavelengths at a rate of 10 Gb/s, the total transfer rate amounts to 500 Gb/s. As can be seen from this example, the WDM optical transmission technology is very convenient for high-capacity data transmission.

Meanwhile, in order to increase efficiency and flexibility of an optical network that puts the WDM optical transmission technology into practice, technology for adding and dropping a wavelength channel at a network node is required. This requirement is realized in fixed optical add-drop multiplexer (FOADM) technology. Furthermore, reconfigurable optical add-drop multiplexer (ROADM) technology makes it possible not only to increase the efficiency of the optical network but also to make economical use of network resources, etc. The use of the ROADM technology allows an arbitrary channel to be added or dropped at an arbitrary node, so that the network can be operated at higher efficiency.

An optical transport network (OTN) is made up of a digital domain and an optical domain. In the digital domain, a maintenance signal of a network apparatus and an overhead signal for system operation, management, etc. can be processed. However, in the optical domain, a separate overhead channel apparatus is required because it is difficult to optically process the overhead signal. Thus, for the purpose of performing this role, a separate optical channel is provided, which is called an optical supervisory channel (OSC).

For the normal operation of the optical network, two neighboring nodes must be maintained so as to be able to exchange signals through the OSC in opposite directions. The OSC has three roles as described below. The first role is directed to a channel for transmitting and receiving the overhead signal required by the optical domain. Here, the overhead signal includes information on maintenance, status of operation, administration, etc. of a main WDM wavelength channel optical signal. This information is defined in ITU-T Recommendation G.709. A structure, bit, etc. of the overhead for an optical transmission section (OTS), an optical multiplex section (OMS), and an optical channel section (OCh), which are classified according to a hierarchical structure of the OTN, are transmitted through the OSC.

The second role is directed to a message communication channel (MCC), which is used as a channel for telecommunication management network (TMN) message communication or network management system/element management system (NMS/EMS) data communication. The last role is directed to a signaling communication channel (SCC), which is used as a channel for transferring a protocol associated with a signaling signal for a network network interface (NNI).

Hereinafter, descriptions will be made to the conventional network node in the optical network that employs the WDM optical transmission technology of this technical background with reference to FIGS. 1 through 3.

FIG. 1 illustrates the basic configuration of a conventional network node.

As illustrated in FIG. 1, the network node has input and output ports of bidirectional optical fibers, and thus is adapted to amplify and output input optical signals. WDM wavelength channel signals are amplified by optical amplifiers (OAs) 13-1 and 13-2, which are connected to the respective optical fibers, and then are output outside the network node through the optical fibers, which are connected to output ports of the OAs 13-1 and 13-2. Here, the WDM wavelength channel signals, which are input into the network node through the bidirectional optical fibers, are identical to each other.

If the optical fiber of one direction is cut off or does not transmit the signal due to problems in, for instance, the OA, the signal transmitted through the optical fiber of the other direction is recognized and processed. In other words, a main signal and a sub-signal are set on the basis of a bidirectional signal transmission system. Thus, when the main signal has a problem with the transmission, the sub-signal is processed. Thereby, the signal is processed without a problem. This is called signal protection.

OSC signals have a wavelength different from the WDM wavelength channel signals, but are transmitted through the same optical fibers as the WDM wavelength channel signals. The OSC signals which are input into the node are split from the WDM wavelength channel signals in OSC-WDM couplers 11-1 and 11-2, and are input into an OSC unit 14. The OSC signals which are output from the OSC unit 14 are coupled again with the WDM wavelength channel signals in OSC-WDM couplers 12-1 and 12-2, transferred through the optical fibers, and output outside the node.

The OSC unit 14 converts the input OSC signal to an electrical signal, and then analyzes information of the converted electrical signal. The OSC unit 14 extracts necessary information from the analyzed information, forms information that must be transmitted to a neighboring node again, and outputs the formed information over the OSC.

Here, the OSC signals transmitted in opposite directions, unlike the WDM wavelength channel signals, may have different pieces of information. As described above, since the OSC performs the roles of the signal maintenance and the communication with the neighboring node over the MCC and SCC, the OSC signals can have quite different pieces of information depending on the state, situation, etc. of each node when transmitted in the opposite directions. When the pieces of information of the OSC signals input into the OSC unit 14 are different from each other, the pieces of information of the OSC signals output from the OSC unit 14 are also different from each other.

FIG. 2 illustrates the configuration of a network node that is implemented by an optical add-drop multiplexer (OADM).

In FIG. 2, the network node includes ROADMs (or FOADMs), each of which can add or drop the WDM wavelength channel. Among the WDM wavelength channels, a specific one is added or dropped by the ROADMs 25. In this case, the OSCs are split from the WDM wavelength channels by OSC-WDM couplers 21-1 and 21-2, each of which is located in front of an input port of the respective ROADM 25, and are combined with the WDM wavelength channel signals by OSC-WDM couplers 22-1 and 22-2, each of which is located behind an output port of the respective ROADM 25. The flow of the OSC signals and the operation of an OSC unit 24 are the same as in the description made with reference to FIG. 1.

FIG. 3 illustrates the configuration of an extended network node.

The nodes illustrated in FIGS. 1 and 2 have a two-degree structure in which only connection of bidirectional optical fibers can be supported. The two-degree node can be extended to realize a multi-degree node (three degrees or more), which is illustrated in FIG. 3. An optical cross-connect 35 can be realized by one or more high-capacity multiple input/output optical switches, or by a plurality of ROADMs.

OSCs are split from WDM wavelength channels by OSC-WDM couplers 31-1, 31-2 . . . 31-n , which are located behind input ports of the multi-degree node, and then are input into an OSC unit 34. After being processed by the OSC unit 34, the OSCs are combined with the WDM wavelength channel signals by OSC-WDM couplers 32-1, 32-2 . . . 32-n, which are located in front of output ports of the multi-degree node, and then are transmitted to the next node through the optical fibers.

The conventional network nodes have been described with reference to FIGS. 1 through 3. It can be found from the description that the OSC unit processing the OSC signals is one in number regardless of whether the conventional network node is the two-degree node that supports the opposite directions or the multi-degree node having at least three degrees. In other words, the single OSC unit processes all the OSC signals, which are dropped and transmitted through the plurality of optical fibers. Thus, in the case in which the single OSC unit is abnormal, or the OSC signals are not properly transmitted, there can be a serious problem. Particularly, in the case of the multi-degree node of FIG. 3, this problem becomes more serious.

Since the maintenance signal is not properly transmitted through the OSC, and the communication with the neighboring node over the MCC and SCC is not properly performed, the state information of the optical network is not transmitted, or optical path provisioning is impossible. Further, as described above, since the OSC signals transmitted in the opposite directions have different pieces of information, the signal protection is not ensured unlike the WDM wavelength channel signals.

### SUMMARY OF THE INVENTION

The present invention provides a network apparatus, which enables the role of an optical supervisory channel (OSC) to be performed properly.

Additional aspects of the invention will be set forth in the description which follows, and in part will be apparent from the description, or may be learned by practice of the invention.

The present invention discloses a network apparatus for guaranteeing the role of an optical supervisory channel (OSC) in an optical network based on wavelength division multiplexing optical transmission technology, wherein at least two OSC units are multiplexed; one of the OSC units is set as a main unit; the other OSC unit is set as an auxiliary unit; and the auxiliary unit is activated when the main unit cannot be operated.

The network apparatus may include: input-port-side optical supervisory channel-wavelength division multiplexing (OSC-WDM) couplers, which split OSCs, which are input through a plurality of input ports, from WDM wavelength channels; channel branch units, which receive the split OSCs from the OSC-WDM couplers, and branch and output the received OSCs; at least two OSC units, which receive the branched and output OSCs, and process and output signals of the received OSCs, wherein the auxiliary unit is activated when the main unit cannot be operated; and channel transmitters, which transmit the OSCs, which are output from the at least two OSC units, to output-port-side OSC-WDM couplers, which correspond to the input-port-side OSC-WDM couplers.

The present invention also discloses a method for guaranteeing the role of an optical supervisory channel (OSC) of a network apparatus, including: splitting OSCs, which are input from a plurality of input ports, from wavelength division multiplexing (WDM) wavelength channels; branching and outputting the OSCs, which are split according to the respective input ports, to at least two OSC units; processing and outputting, by one of the OSC units, signals of the branched and output OSCs, wherein one of the OSC units is set as a main unit, the other OSC unit is set as an auxiliary unit, and the auxiliary unit processes and outputs the OSC signals when the main unit cannot be operated; and recombining the output OSCs with the WDM wavelength channels before split, and outputting the recombined OSCs to the outside.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 illustrates the basic configuration of a conventional network node.

FIG. 2 illustrates the configuration of a conventional network node that is implemented by an optical add-drop multiplexer (OADM).

FIG. 3 illustrates the configuration of a conventional extended network node.

FIG. 4 illustrates the configuration of a network node according to an exemplary embodiment of the present invention.

FIG. 5 illustrates the configuration of a network node that is implemented by an OADM in accordance with an exemplary embodiment of the present invention.

FIG. 6 illustrates the configuration of an extended network node according to an exemplary embodiment of the present invention.

FIG. 7 is a flow chart illustrating the operation of a network node according to an exemplary embodiment of the present invention.

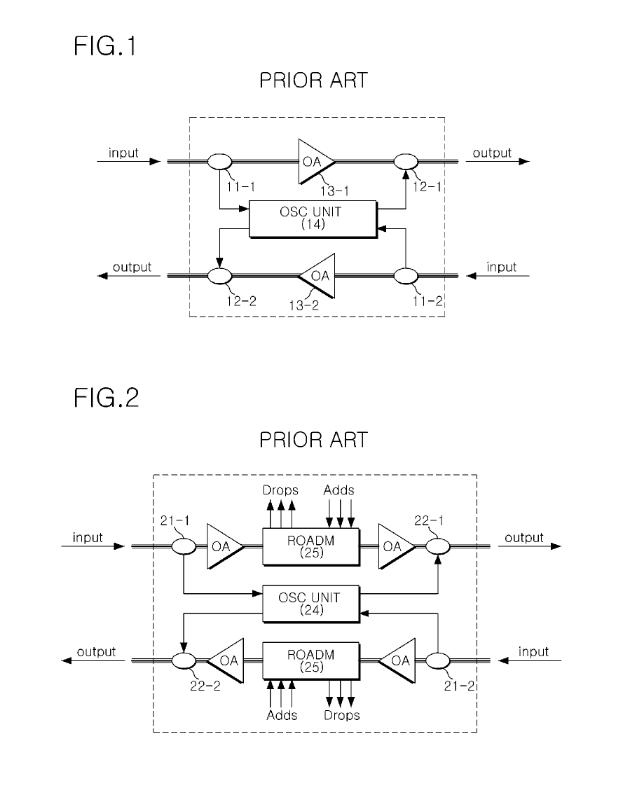

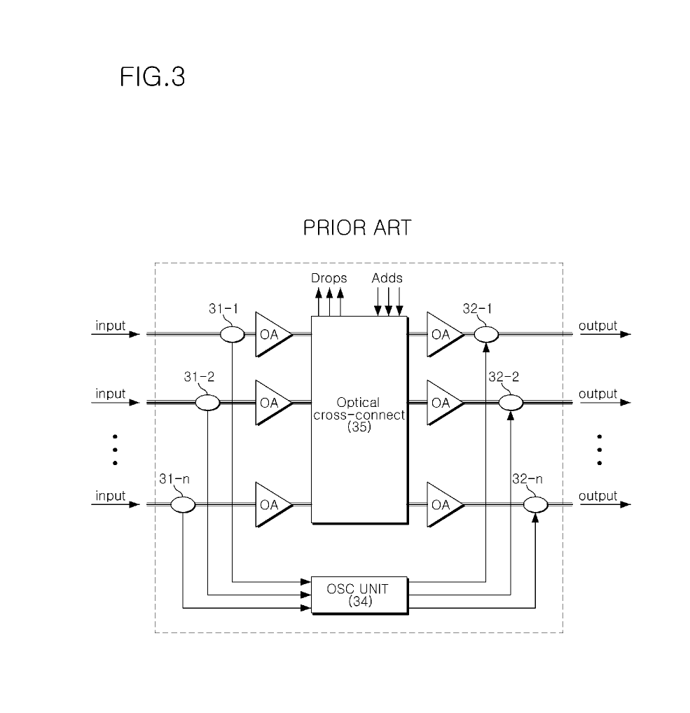

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

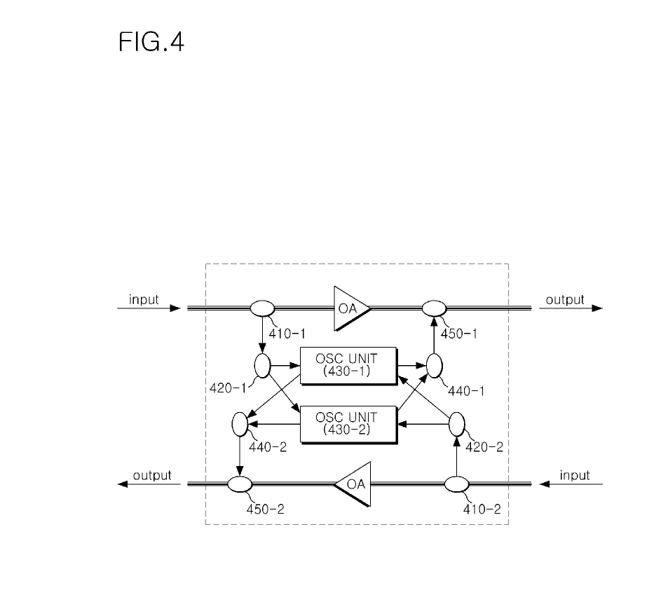

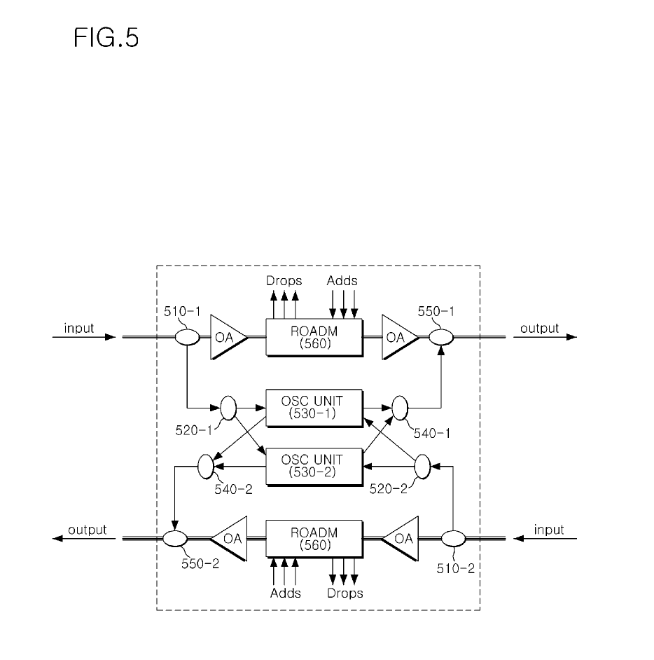

FIG. 4 illustrates the configuration of a network node according to an exemplary embodiment of the present invention.

In FIG. 4, it is assumed that signals are transmitted through bidirectional optical fibers in consideration of the state in which two neighboring nodes can exchange signals through an optical supervisory channel (OSC) in opposite directions in order to ensure normal operation of an optical network. As illustrated, the network node includes input-port-side optical supervisory channel-wavelength division multiplexing (OSC-WDM) couplers 410-1 and 410-2, channel branch units 420-1 and 420-2, OSC units 430-1 and 430-2, channel transmitters 440-1 and 440-2, and output-port-side OSC-WDM couplers 450-1 and 450-2.

Each of the input-port-side OSC-WDM couplers 410-1 and 410-2 splits the OSC and a WDM wavelength channel from a channel transmitted through the optical fiber. The OSCs, which are split from the WDM wavelength channels by the input-port-side OSC-WDM couplers 410-1 and 410-2, are input into the respective channel branch units 420-1 and 420-2. The channel branch units 420-1 and 420-2 branch and output the input OSC channels to the OSC units 430-1 and 430-2. In this embodiment, the channel branch units 420-1 and 420-2 include optical couplers or optical switches.

The OSC units 430-1 and 430-2 convert signals carried on the OSCs to electrical signals, and then analyze information of the converted electrical signals. The OSC units 430-1 and 430-2 extract necessary information from the analyzed information, form information that must be transmitted to a neighboring node again, and output the formed information over the OSC.

In this embodiment, the OSC unit 430-1 serves as a main unit, while the OSC unit 430-2 serves as an auxiliary unit. Here, the auxiliary unit 430-2 performs its role only when the main unit 430-1 cannot carry out normal operation. If three or more OSC units are installed and thus two or more OSC units serve as the auxiliary units, the auxiliary units are operated according to priority.

A processor, which takes charge of an optical communication system configuring the optical network node, checks at all times whether or not all the units are operating normally in the system, whether or not the optical fiber is cut off, and so on. This is also true of the OSC units. Thus, when the main unit 430-1 has a problem in normal operation, this is checked by the processor, which takes charge of the optical communication system configuring the optical network node, so that the auxiliary unit 430-2 is operated.

The channel transmitters 440-1 and 440-2 receive the OSCs, which are output from the OSC units 430-1 and 430-2. For example, in the case in which the normal operation of the main unit 430-1 is impossible, the OSC output from the auxiliary unit 430-2 is input into all the channel transmitters 440-1 and 440-2. The channel transmitters 440-1 and 440-2 output the input OSCs to the corresponding output-port-side OSC-WDM couplers 450-1 and 450-2. In other words, the channel transmitters 440-1 and 440-2 output the OSCs, which are split from the WDM wavelength channels, to the output-port-side OSC-WDM couplers, which are connected to the input-port-side OSC-WDM couplers through the optical fibers. In this embodiment, the channel transmitters 440-1 and 440-2 include optical couplers or optical switches.

The output-port-side OSC-WDM couplers 450-1 and 450-2 combine the input OSCs with the WDM wavelength channels again, and then transmit the combined channels to the next node through the optical fibers.

FIG. 5 illustrates the configuration of a network node that is implemented by an optical add-drop multiplexer (OADM) in accordance with an exemplary embodiment of the present invention.

In FIG. 5, the network node includes reconfigurable optical add-drop multiplexers (ROADMs) (or fixed optical add-drop multiplexers (FOADMs)), each of which can add or drop the WDM wavelength channel. Among the WDM wavelength channels, a specific one is added or dropped by the ROADMs 560. In this case, the OSCs are split from the WDM wavelength channels by OSC-WDM couplers 510-1 and 510-2, each of which is located in front of an input port of each ROADM 560, and are combined with the WDM wavelength channels by OSC-WDM couplers 550-1 and 550-2, each of which is located behind an output port of each ROADM 560. In the case of other elements such as channel branch units 520-1 and 520-2, channel transmitters 540-1 and 540-2, and OSC units 530-1 and 530-2, though their reference numbers are different from those of FIG. 4, their operations are the same as in the description made with reference to FIG. 4.

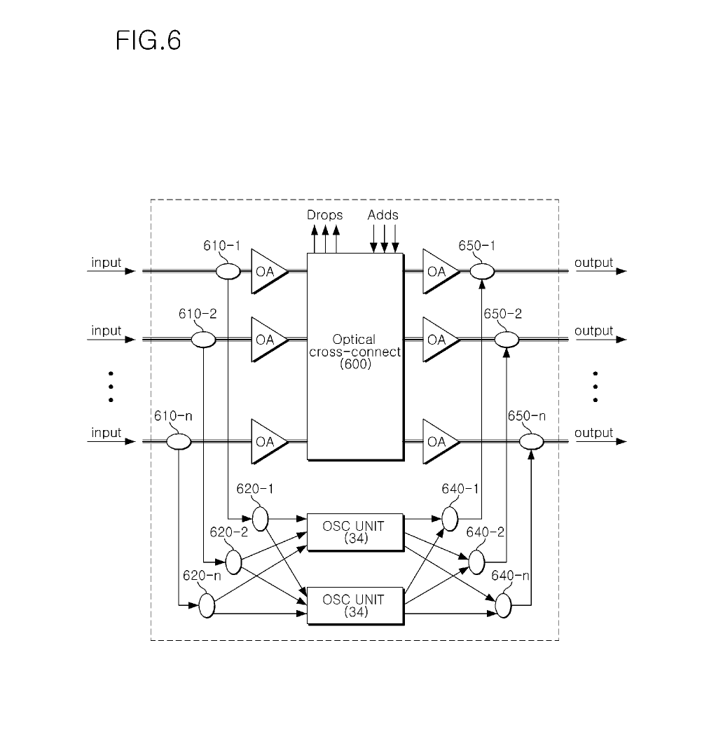

FIG. 6 illustrates the configuration of an extended network node according to an exemplary embodiment of the present invention.

The nodes illustrated in FIGS. 4 and 5 have a two-degree structure in which only connection of the bidirectional optical fibers can be supported. The two-degree node can be extended to realize a multi-degree node (three degrees or more), which is illustrated in FIG. 6. An optical cross-connect 660 can be realized by at least one high-capacity multiple input/output optical switch, or by a plurality of ROADMs.

OSCs are split from WDM wavelength channels by OSC-WDM couplers 610-1, 610-2 . . . 610-n, which are located behind the respective input ports of the multi-degree node. After being processed by OSC units 630-1 and 630-2, the OSCs are combined with the WDM wavelength channels by OSC-WDM couplers 650-1, 650-2 . . . 650-n, which are located in front of output ports of the multi-degree node, and then are transmitted to the next node through the optical fibers. In the case of other elements such as channel branch units 620-1, 620-2 . . . 620-n, channel transmitters 640-1, 640-2 . . . 640-n, and OSC units 630-1 and 630-2, though their reference numbers are different from those of FIG. 4, their operations are the same as in the description made with reference to FIG. 4.

As described above, the network nodes according to the present invention have been reviewed with reference to FIGS. 4 through 6. For the convenience of description, it is assumed that the number of OSC units is, but not limited to, two. Thus, the number of OSC units may be increased as needed.

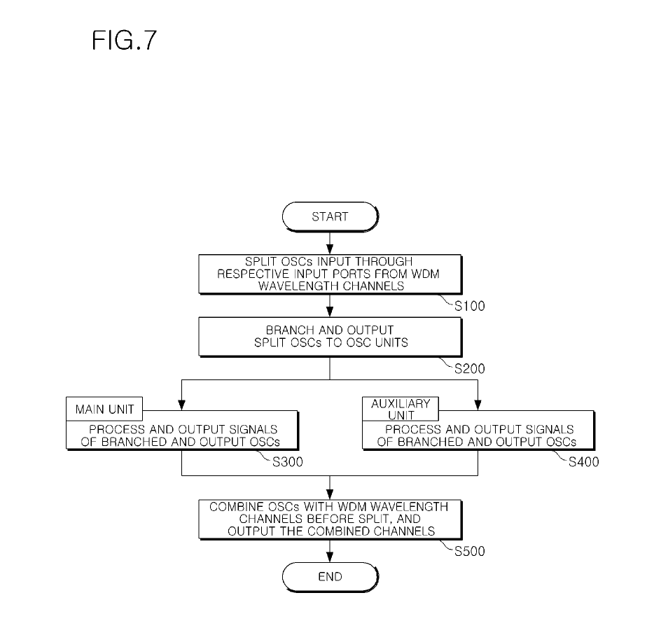

FIG. 7 is a flow chart illustrating the operation of a network node according to an exemplary embodiment of the present invention.

The OSCs, which are input through the respective input ports, are split from the WDM wavelength channels (S100). This can be realized by the OSC-WDM couplers, which are provided to the respective input ports. Then, the split OSCs are branched and output to the main and auxiliary units (S200). At this time, the split OSCs can be branched and output using optical couplers or switches. The use of the optical couplers allows the OSCs to be output to all of the main and auxiliary units, whereas the use of the optical switches allows the OSCs to be output only to the activated one of the main and auxiliary units.

When the main unit is operating normally, it processes and outputs the signals of the branched and output OSCs (S300). In contrast, when the auxiliary unit is set to be able to perform normal operation, the auxiliary unit processes and outputs the signals of the branched and output OSCs (S400). When step S300 or step S400 is performed, the OSCs output from the main unit or the auxiliary unit are combined with the WDM wavelength channels before they are split, and then are output outside the network node (S500).

According to the present invention, at least two OSC units are multiplexed; one of the OSC units is set as a main unit; the other OSC unit is set as an auxiliary unit; and the auxiliary unit is activated when the main unit cannot be operated. Thereby, the OSC signals can be stably transmitted, and the signal protection can be guaranteed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A network apparatus for guaranteeing a role of an optical supervisory channel (OSC) in an optical network based on wavelength division multiplexing optical transmission technology, wherein at least two OSC units are multiplexed; one of the OSC units is set as a main unit; the other OSC unit is set as an auxiliary unit; and the auxiliary unit is activated when the main unit cannot be operated.

2. The network apparatus of claim 1, wherein the network apparatus comprises:
input-port-side optical supervisory channel-wavelength division multiplexing (OSC-WDM) couplers, which split OSCs, which are input through a plurality of input ports, from WDM wavelength channels;
channel branch units, which receive the split OSCs from the OSC-WDM couplers, and branch and output the received OSCs;
at least two OSC units, which receive the branched and output OSCs, and process and output signals of the received OSCs, wherein the auxiliary unit is activated when the main unit cannot be operated; and
channel transmitters, which transmit the OSCs, which are output from the at least two OSC units, to output-port-side OSC-WDM couplers, which correspond to the input-port-side OSC-WDM couplers.

3. The network apparatus of claim 2, wherein each of the channel branch units comprises one of an optical coupler and an optical switch.

4. The network apparatus of claim 2, wherein each of the channel transmitters comprises one of an optical coupler and an optical switch.

5. A method for guaranteeing a role of an optical supervisory channel (OSC) of a network apparatus, comprising:
splitting OSCs, which are input from a plurality of input ports, from wavelength division multiplexing (WDM) wavelength channels;
branching and outputting the OSCs, which are split according to the respective input ports, to at least two OSC units;
processing and outputting, by one of the OSC units, signals of the branched and output OSCs, wherein one of the OSC units is set as a main unit, the other OSC unit is set as an auxiliary unit, and the auxiliary unit processes and outputs the OSC signals when the main unit cannot be operated; and
recombining the output OSCs with the WDM wavelength channels before split, and outputting the recombined OSCs to the outside.
